(19) United States
(12) Patent Application Publication
(10) Pub. No.: US 2025/0169619 A1
(43) Pub. Date: May 29, 2025

(54) JOINT COMPONENTS AND BABY CHANGING STATION INCLUDING THE JOINT COMPONENTS

(71) Applicant: Foshan BeeKoo Intelligent Technology Co.,Ltd, Foshan (CN)

(72) Inventor: HUASHENG CHEN, Foshan (CN)

(21) Appl. No.: 18/744,861

(22) Filed: Jun. 17, 2024

(30) Foreign Application Priority Data
Nov. 28, 2023 (CN) 202311612402.2

(51) Int. Cl. A47D 5/00

(52) U.S. Cl. CPC A47D 5/006

(57) ABSTRACT

The present invention discloses a joint component and a baby changing station including the joint component, and the joint component includes a first joint, a second joint that is rotatably disposed on the first joint, and a first elastic locking rod, and the two ends of the first elastic locking rod are respectively provided with a first moving end and a first locking end, the first joint is provided with a first mounting space, and the first elastic locking rod is movably disposed on the first mounting space, and the first moving end and the first locking end extend outside the first mounting space, the joint component controls the relative rotation and locking of the second joint through the first elastic locking rod, making the unfolding and folding operation of the second joint simple and labor-saving, and the second joint stable after unfolding.

### CROSS-REFERENCE TO RELATED APPLICATIONS

This application claims priority to Chinese Patent Application No. 202311612402.2, filed on Nov. 28, 2023, which is hereby incorporated by reference in its entirety.

### TECHNICAL FIELD

The present invention relates to the technical field of baby care equipment, particularly to a joint component and a baby changing station including the joint component.

### BACKGROUND

An existing baby changing station, as detailed in the Chinese utility model patent numbered 2020204310309, name: a baby changing station, authorized announcement date: Feb. 9, 2021, includes a support frame, a load-bearing frame, and a table top; the load-bearing frame is movably connected to the support frame and supports the tabletop, and the support frame, load-bearing frame, and tabletop are all foldable structures. The utility model can be folded and supports the table top through a load-bearing frame, providing the table top with large load-bearing capacity.

In the baby changing station mentioned above, the first front support rod, the second front support rod, the first rear support rod, and the second rear support rod can all be assembled by two spliced short rods, the middle part of the first front support rod is hinged to the middle part of the second front support rod, and the middle part of the first rear support rod is hinged to the middle part of the second rear support rod.

However, the baby changing station with the above structure still has the following shortcomings: (1) The adjacent two support rods are folded through central hinge and, in order to ensure the central connection stability between the adjacent two support rods, the locking force of the adjacent two support rods will be increased during hinge connection, making it difficult for the two support rods to fold.

### SUMMARY

The purpose of the present invention is to address the shortcomings of the prior art and provide a joint component that is easy to unfold and fold, labor-saving, and stable after unfolding.

Another purpose of the present invention is to provide a baby changing station with simple and labor-saving unfolding and folding operations, stable joint components after unfolding, and smaller volume after folding.

The purpose of the present invention is realized as follows:
A joint component, including a first joint, a second joint that is rotatably disposed on the first joint, and a first elastic locking rod, wherein the two ends of the first elastic locking rod are respectively provided with a first moving end and a first locking end, the first joint is provided with a first mounting space, and the first elastic locking rod is movably disposed on the first mounting space, and the first moving end and the first locking end extend outside the first mounting space, respectively, a second locking hole is provided at the position of the second joint corresponding to the first locking end, and the first locking end extends into the second locking hole;
For the joint component, when it is necessary to unfold the second joint, it is simply required to rotate the second joint until the first elastic locking rod corresponds to the second locking hole on the second joint, then the first locking end of the first elastic locking rod will be inserted into the second locking hole; if it is necessary to fold the second joint, it is simply required to pull the first moving end away from second locking hole, then the second joint can be easily rotated for folding purpose, and the entire process is simple and labor-saving, and the insertion of the first locking end into the second locking hole can maintain the relative locking of the second joint on the first joint, thereby ensuring the stable state of the second joint after unfolding.

The purpose of the present invention can also be solved by the following technical measures:

Specifically, the first elastic locking rod includes a first moving block, a first spring, and a first locking rod, the first moving block is fixedly connected to one end of the first locking rod, and the other end of the first locking rod is provided with the first locking end, the first moving block forms the first moving end, and the two ends of the first spring are respectively pressed against the side wall of first mounting space and the first locking rod; the first moving block facilitates the user to pull the first locking rod to move, so that the first spring is compressed and when the user releases the first moving block, the first locking rod will move under the elastic resetting force of the first spring.

Specifically, one end of the first locking rod extends out of a first locking block, the first locking block is provided with a hemispherical first locking end, and the center of other end of the first locking rod is provided outwardly with a first connecting column, one end of the first connecting column extends out of the first mounting space and is fixedly connected to the first moving block, the first spring is sleeved on the first connecting column, and the two ends of the first spring are respectively pressed against the side wall of the first mounting space and the other end of the rod of the first locking block; the hemispherical first locking end facilitates its extension into the second locking hole, and the first connecting column provides a stable connecting carrier for the first spring, thereby stabilizing the contact between the first spring and the first locking rod.

Specifically, the first moving block is provided with a placement groove and a through sink hole connected to the placement groove, one end of the first connecting column is inserted into the placement groove, and a through hole is provided at the position on the first connecting column corresponding to the through sink hole, and a connecting screw extends from top to bottom into the through sink hole and passes through the through hole of the first connecting column, so that the first moving block is stably connected to one end of the first connecting column, and at the same time, this screw connection method is easy to operate and implement.

Specifically, the joint component further includes a third joint and a second elastic locking rod, the third joint is rotatably disposed on the first joint and is located above the second joint, and the two ends of the second elastic locking rod are the second moving end and the second locking end, respectively, the first joint is provided with a second mounting space, and the second elastic locking rod is movably disposed on the second mounting space, and the second moving end and the second locking end extends respectively outside the second mounting space, and a third locking hole is provided at the position on the third joint corresponding to the second locking end, and the second locking end extends into the third locking hole; the third joint is unfolded and folded on the first joint through a second elastic locking rod, which is relatively simple and labor-saving to operate and, in addition, the second locking end that fits the third locking hole maintains relative locking of the third joint on the first joint, thereby ensuring the stability of the third joint after unfolding.

Specifically, the joint component further includes a fourth joint and a third elastic locking rod, the fourth joint is rotatably disposed on the first joint and is located above the third joint, and the two ends of the third elastic locking rod are the third moving end and the third locking end, respectively, and the first joint is provided with a third mounting space, and the third elastic locking rod is movably disposed on the third mounting space, and the third moving end and the third locking end respectively extends out of the third mounting space, and a fourth joint is provided at the position on the fourth locking hole corresponding to the third locking end, and the third locking end extends into the fourth locking hole; the fourth joint is unfolded and folded on the first joint through the third elastic locking rod, which is relatively simple and labor-saving to operate and, in addition, the third locking end that fits the fourth locking hole maintains relative locking of the fourth joint on the first joint, thereby ensuring the stability of the fourth joint after unfolding.

Specifically, the first joint is provided with a first limiting portion, the second joint is provided with a second lower limit portion and a second upper limit portion, the third joint is provided with a third lower limit portion and a third upper limit portion, and the fourth joint is provided with a fourth limiting portion, the first limiting portion is pressed against the second lower limit portion, the second upper limit portion is pressed against the third lower limit portion, and the third upper limit part is pressed against the fourth limit part; the mutual close contact and fitting among all limiting parts controls the limit position of the second joint, third joint, and fourth joint in the unfolded state, making it easier for users to rotate.

Specifically, the first joint is provided with a circular convex edge, the second joint, the third joint, and the fourth joint are sequentially disposed on the outer circumference of the circular convex edge, and an mounting base is provided on the inner circumference of the circular convex edge, and the mounting base is internally provided with the first mounting space, the second mounting space, and the third mounting space; the circular convex edge facilitates the rotation of the second, third, and fourth joints on the first joint; the mounting base which is simple in structure and easy to implement provides a carrier for the first, second, and third mounting spaces.

Specifically, the joint component further includes a moving base, the moving base is provided with an inner groove, a first moving groove, a second moving groove, and a third moving groove; the first moving groove, second moving groove, and third moving groove are respectively connected to the inner groove, and the moving base is sleeved on the outer side of the mounting base through the inner groove, the first moving end extends into the first moving groove, the second moving end extends into the second moving groove, and the third moving end extends into the third moving groove; the moving base can simultaneously move the first, second, and third moving ends, simultaneous rotating the second, third, and fourth joints with ideal implementation effect.

Another purpose of the present invention is realized as follows: a baby changing station comprising above joint components includes two joint components, a first bracket, a second bracket, a support frame, a tablecloth, and four support feet; the two ends of the first bracket are fixedly connected to the first joint of the two joint components, the two ends of the second bracket are fixedly connected to the second joint of the two joint components, and the four support feet are fixedly connected to the third joint and fourth joint of the two joint components, the two ends of the support frame are rotatably connected to the first bracket and the second bracket, and the two ends of tablecloth are respectively disposed on the upper part of first bracket and the upper part of second bracket, and the tablecloth is located above the support frame; this baby changing station can be folded or unfolded through two joint components, including the first bracket, second bracket, and four supporting feet, which is relatively simple and labor-saving to operate and, additionally, when the baby changing station is being folded, both the first bracket and second bracket can be folded downward, and the four supporting feet can be folded inward, so that the first bracket, second bracket, and four supporting feet overlap, ensuring a small volume and occupation space, and convenient placement after the baby changing station is folded.

The beneficial effects of the present invention are as follows:

(1) For the joint component, when it is necessary to unfold the second joint, it is simply required to rotate the second joint until the first elastic locking rod corresponds to the second locking hole on the second joint, then the first locking end of the first elastic locking rod will be inserted into the second locking hole; if it is necessary to fold the second joint, it is simply required to pull the first moving end away from second locking hole, then the second joint can be easily rotated for folding purpose, and the entire process is simple and labor-saving, and the insertion of the first locking end into the second locking hole can maintain the relative locking of the second joint on the first joint, thereby ensuring the stable state of the second joint after unfolding.

(2) The mutual close contact and fitting among all limiting parts controls the limit position of the second joint, third joint, and fourth joint in the unfolded state, making it easier for users to rotate.

(3) The baby changing station can be folded or unfolded through two joint components, including the first bracket, second bracket, and four supporting feet, which is relatively simple and labor-saving to operate and, additionally, when the baby changing station is being folded, both the first bracket and second bracket can be folded downward, and the four supporting feet can be folded inward, so that the first bracket, second bracket, and four supporting feet overlap, ensuring a small volume and occupation space, and convenient placement after the baby changing station is folded.

### BRIEF DESCRIPTION OF DRAWINGS

FIG. 1 is a schematic diagram of the joint components of the present invention.

FIG. 2 is a sectional view of the joint component of the present invention.

FIG. 3 is an enlarged view of position A in FIG. 2.

FIG. 4 is a disassembly diagram of the joint component of the present invention.

FIG. 5 is a disassembly diagram of the first elastic locking rod of the present invention.

FIG. 6 is a schematic diagram of the unfolded baby changing station of the present invention.

FIG. 7 is a schematic diagram of the folded baby changing station of the present invention.

### DESCRIPTION OF EMBODIMENTS

The present invention will be further described in conjunction with the accompanying drawings and the embodiments:

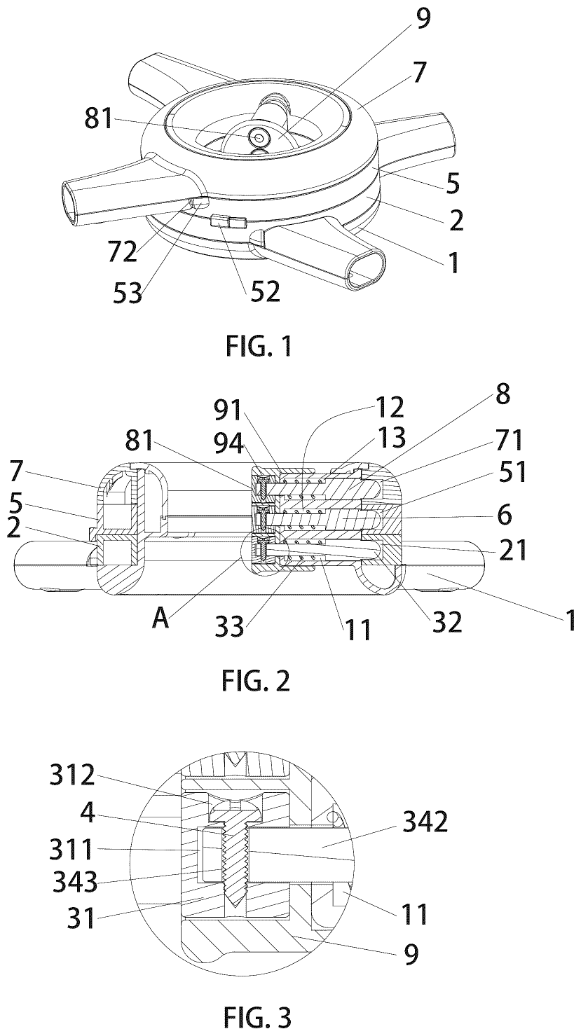

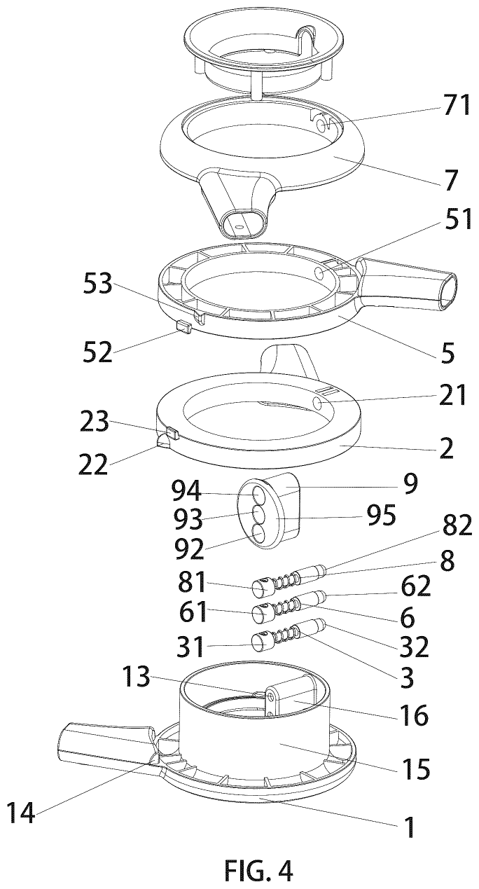

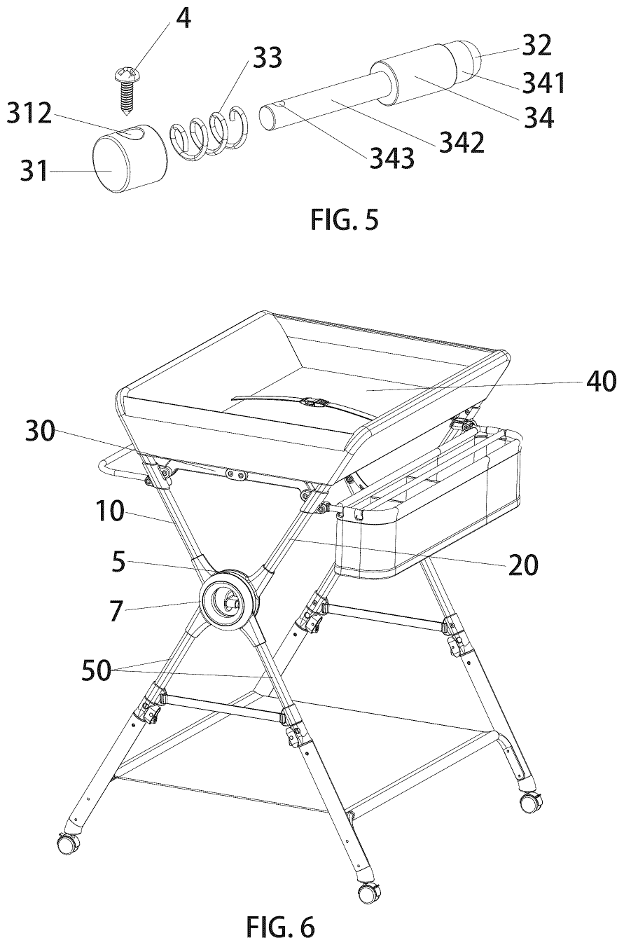

In the embodiment, as shown in FIGS. 1 to 5, the joint component includes a first joint 1, a second joint 2 that is rotatably disposed on the first joint 1, and a first elastic locking rod (3), wherein the two ends of the first elastic locking rod 3 are respectively provided with a first moving end 31 and a first locking end 32, the first joint 1 is provided with a first mounting space 11, and the first elastic locking rod 3 is movably disposed on the first mounting space 11, and the first moving end 31 and the first locking end 32 extend outside the first mounting space 11, respectively, a second locking hole 21 is provided at the position of the second joint 2 corresponding to the first locking end 32, and the first locking end 32 extends into the second locking hole 21.

As a specific embodiment, the first elastic locking rod 3 includes a first moving block, a first spring 33, and a first locking rod 34, the first moving block is fixedly connected to one end of the first locking rod 34, and the other end of the first locking rod 34 is provided with the first locking end 32, the first moving block forms the first moving end 31, and the two ends of the first spring 33 are respectively pressed against the side wall of first mounting space 11 and the first locking rod 34.

In this embodiment, one end of the first locking rod 34 extends out of a first locking block 341, the first locking block 341 is provided with a hemispherical first locking end 32, and the center of other end of the first locking rod 34 is provided outwardly with a first connecting column 342, one end of the first connecting column 342 extends out of the first mounting space 11 and is fixedly connected to the first moving block, the first spring 33 is sleeved on the first connecting column 342, and the two ends of the first spring 33 are respectively pressed against the side wall of the first mounting space 11 and the other end of the rod 34 of the first locking block.

In the embodiment, the first moving block is provided with a placement groove 311 and a through sink hole 312 connected to the placement groove 311, one end of the first connecting column 342 is inserted into the placement groove 311, and a through hole 343 is provided at the position on the first connecting column 342 corresponding to the through sink hole 312, and a connecting screw 4 extends from top to bottom into the through sink hole 312 and passes through the through hole 343 of the first connecting column 342.

As a more specific solution, the joint component further includes a third joint 5 and a second elastic locking rod 6, the third joint 5 is rotatably disposed on the first joint 1 and is located above the second joint 2, and the two ends of the second elastic locking rod 6 are the second moving end 61 and the second locking end 62, respectively, the first joint 1 is provided with a second mounting space 12, and the second elastic locking rod 6 is movably disposed on the second mounting space 12, and the second moving end 61 and the second locking end 62 extends respectively outside the second mounting space 12, and a third locking hole 51 is provided at the position on the third joint 5 corresponding to the second locking end 62, and the second locking end 62 extends into the third locking hole 51.

As a better embodiment, the joint component further includes a fourth joint 7 and a third elastic locking rod 8, the fourth joint 7 is rotatably disposed on the first joint 1 and is located above the third joint 5, and the two ends of the third elastic locking rod 8 are the third moving end 81 and the third locking end 82, respectively, and the first joint 1 is provided with a third mounting space 13, and the third elastic locking rod 8 is movably disposed on the third mounting space 13, and the third moving end 81 and the third locking end 82 respectively extends out of the third mounting space 13, and a fourth joint 7 is provided at the position on the fourth locking hole 71 corresponding to the third locking end 82, and the third locking end 82 extends into the fourth locking hole 71.

The second elastic locking rod 6, the third elastic locking rod 8, and the first elastic locking rod 3 have the same structure, which will not be elaborated here.

In the embodiment, the first joint (1) is provided with a first limiting portion 14, the second joint 2 is provided with a second lower limit portion 22 and a second upper limit portion 23, the third joint 5 is provided with a third lower limit portion 52 and a third upper limit portion 53, and the fourth joint 7 is provided with a fourth limiting portion 72, the first limiting portion 14 is pressed against the second lower limit portion 22, the second upper limit portion 23 is pressed against the third lower limit portion 52, and the third upper limit part 53 is pressed against the fourth limit part 72; more specifically, the first limit portion 14 and the fourth limit portion 72 are all limit surfaces, and the second lower limit portion 22, the second upper limit portion 23, the third lower limit portion 52, and the third upper limit portion 53 are all limit blocks.

In the embodiment, the first joint 1 is provided with a circular convex edge 15, the second joint 2, the third joint 5, and the fourth joint 7 are sequentially disposed on the outer circumference of the circular convex edge 15, and an mounting base 16 is provided on the inner circumference of the circular convex edge 15, and the mounting base 16 is internally provided with the first mounting space 11, the second mounting space 12, and the third mounting space 13.

As a better embodiment, the joint component further includes a moving base 9, the moving base 9 is provided with an inner groove 91, a first moving groove 92, a second moving groove 93, and a third moving groove 94; the first moving groove 92, second moving groove 93, and third moving groove 94 are respectively connected to the inner groove 91, and the moving base 9 is sleeved on the outer side of the mounting base 16 through the inner groove 91, the first moving end 31 extends into the first moving groove 92, the second moving end 61 extends into the second moving groove 93, and the third moving end 81 extends into the third moving groove 94; an extension portion 95 that is convenient for users to pull extends outward at one end of the moving base 9.

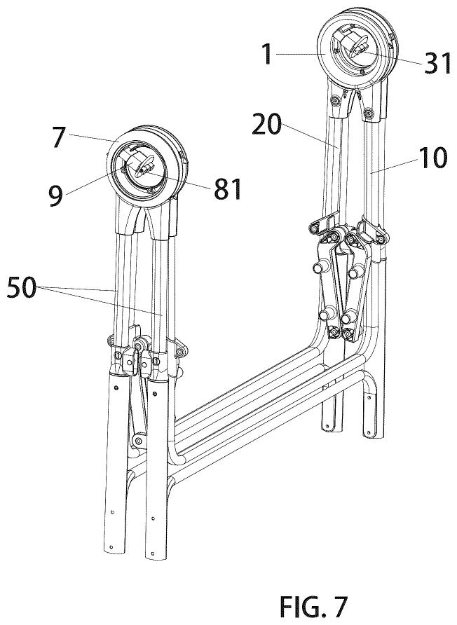

In combination with FIGS. 6 and 7, a baby changing station comprising above joint components includes two joint components, a first bracket 10, a second bracket 20, a support frame 30, a tablecloth 40, and four support feet 50; the two ends of the first bracket 10 are fixedly connected to the first joint 1 of the two joint components, the two ends of the second bracket 20 are fixedly connected to the second joint 2 of the two joint components, and the four support feet 50 are fixedly connected to the third joint 5 and fourth joint 7 of the two joint components, the two ends of the support frame 30 are rotatably connected to the first bracket 10 and the second bracket 20, and the two ends of tablecloth 40 are respectively disposed on the upper part of first bracket 10 and the upper part of second bracket 20, and the tablecloth 40 is located above the support frame 30.

What is claimed is:

1. The joint component, including a first joint (1), a second joint (2) that is rotatably disposed on the first joint (1), and a first elastic locking rod (3), wherein the two ends of the first elastic locking rod (3) are respectively provided with a first moving end (31) and a first locking end (32), the first joint (1) is provided with a first mounting space (11), and the first elastic locking rod (3) is movably disposed on the first mounting space (11), and the first moving end (31) and the first locking end (32) extend outside the first mounting space (11), respectively, a second locking hole (21) is provided at the position of the second joint (2) corresponding to the first locking end (32), and the first locking end (32) extends into the second locking hole (21).

2. The joint component according to claim 1, wherein the first elastic locking rod (3) includes a first moving block, a first spring (33), and a first locking rod (34), the first moving block is fixedly connected to one end of the first locking rod (34), and the other end of the first locking rod (34) is provided with the first locking end (32), the first moving block forms the first moving end (31), and the two ends of the first spring (33) are respectively pressed against the side wall of first mounting space (11) and the first locking rod (34).

3. The joint component according to claim 2, wherein one end of the first locking rod (34) extends out of a first locking block (341), the first locking block (341) is provided with a hemispherical first locking end (32), and the center of other end of the first locking rod (34) is provided outwardly with a first connecting column (342), one end of the first connecting column (342) extends out of the first mounting space (11) and is fixedly connected to the first moving block, the first spring (33) is sleeved on the first connecting column (342), and the two ends of the first spring (33) are respectively pressed against the side wall of the first mounting space (11) and the other end of the rod (34) of the first locking block.

4. The joint component according to claim 3, wherein the first moving block is provided with a placement groove (311) and a through sink hole (312) connected to the placement groove (311), one end of the first connecting column (342) is inserted into the placement groove (311), and a through hole (343) is provided at the position on the first connecting column (342) corresponding to the through sink hole (312), and a connecting screw (4) extends from top to bottom into the through sink hole (312) and passes through the through hole (343) of the first connecting column (342).

5. The joint component according to claim 1, further including a third joint (5) and a second elastic locking rod (6), the third joint (5) is rotatably disposed on the first joint (1) and is located above the second joint (2), and the two ends of the second elastic locking rod (6) are the second moving end (61) and the second locking end (62), respectively, the first joint (1) is provided with a second mounting space (12), and the second elastic locking rod (6) is movably disposed on the second mounting space (12), and the second moving end (61) and the second locking end (62) extends respectively outside the second mounting space (12), and a third locking hole (51) is provided at the position on the third joint (5) corresponding to the second locking end (62), and the second locking end (62) extends into the third locking hole (51).

6. The joint component according to claim 5, further including a fourth joint (7) and a third elastic locking rod (8), the fourth joint (7) is rotatably disposed on the first joint (1) and is located above the third joint (5), and the two ends of the third elastic locking rod (8) are the third moving end (81) and the third locking end (82), respectively, and the first joint (1) is provided with a third mounting space (13), and the third elastic locking rod (8) is movably disposed on the third mounting space (13), and the third moving end (81) and the third locking end (82) respectively extends out of the third mounting space (13), and a fourth joint (7) is provided at the position on the fourth locking hole (71) corresponding to the third locking end (82), and the third locking end (82) extends into the fourth locking hole (71).

7. The joint component according to claim 6, wherein the first joint (1) is provided with a first limiting portion (14), the second joint (2) is provided with a second lower limit portion (22) and a second upper limit portion (23), the third joint (5) is provided with a third lower limit portion (52) and a third upper limit portion (53), and the fourth joint (7) is provided with a fourth limiting portion (72), the first limiting portion (14) is pressed against the second lower limit portion (22), the second upper limit portion (23) is pressed against the third lower limit portion (52), and the third upper limit part (53) is pressed against the fourth limit part (72).

8. The joint component according to claim 6, wherein the first joint (1) is provided with a circular convex edge (15), the second joint (2), the third joint (5), and the fourth joint (7) are sequentially disposed on the outer circumference of the circular convex edge (15), and an mounting base (16) is provided on the inner circumference of the circular convex edge (15), and the mounting base (16) is internally provided with the first mounting space (11), the second mounting space (12), and the third mounting space (13).

9. The joint component according to claim 8, further including a moving base (9), the moving base (9) is provided with an inner groove (91), a first moving groove (92), a second moving groove (93), and a third moving groove (94); the first moving groove (92), second moving groove (93), and third moving groove (94) are respectively connected to the inner groove (91), and the moving base (9) is sleeved on the outer side of the mounting base (16) through the inner groove (91), the first moving end (31) extends into the first moving groove (92), the second moving end (61) extends into the second moving groove (93), and the third moving end (81) extends into the third moving groove (94).

10. The baby changing station comprising any one of the joint components as claimed in claim 6, including two joint components, a first bracket (10), a second bracket (20), a support frame (30), a tablecloth (40), and four support feet (50); the two ends of the first bracket (10) are fixedly connected to the first joint (1) of the two joint components, the two ends of the second bracket (20) are fixedly connected to the second joint (2) of the two joint components, and the four support feet (50) are fixedly connected to the third joint (5) and fourth joint (7) of the two joint components, the two ends of the support frame (30) are rotatably connected to the first bracket (10) and the second bracket (20), and the two ends of tablecloth (40) are respectively disposed on the upper part of first bracket (10) and the upper part of second bracket (20), and the tablecloth (40) is located above the support frame (30).
